(19) United States
(12) Patent Application Publication
(10) Pub. No.: US 2026/0286143 A1
(43) Pub. Date: Sep. 24, 2026

(54) FOULING CONTROL COATING COMPOSITION

(71) Applicant: Akzo Nobel Coatings International B.V., Amsterdam (NL)

(72) Inventors: Robin Alexander Heath, Amsterdam (NL); James Ferguson, Amsterdam (NL); Alistair Andrew Finnie, Amsterdam (NL)

(21) Appl. No.: 19/477,557

(22) PCT Filed: May 6, 2024
(86) PCT No.: PCT/EP2024/062443

§ 371 Date: Oct. 22, 2025

(30) Foreign Application Priority Data
May 4, 2023 (EP) 23171702.6
May 1, 2024 (WO) PCT/EP2024/062003

(51) Int. Cl. C09D 5/16; C08K 5/17; C09D 7/63; C09D 143/04

(52) U.S. Cl. CPC C09D 5/16; C08K 5/17; C09D 7/63; C09D 143/04

(57) ABSTRACT

The disclosure relates to a fouling control coating composition comprising (i) a siloxane-modified anionic polymer with one or more metallic cations, and (ii) an amine compound having at least one amine group attached to a saturated carbon atom, a boiling point of at least 85° C., and a molecular weight of at least 70. The coating is particularly useful as a self-polishing fouling control coating.

### CROSS REFERENCE TO RELATED APPLICATION

This application is a 35 U.S.C. § 371 national phase application of PCT Application No. PCT/EP2024/062443 (published as WO/2024/227955), filed May 6, 2024, which claims the benefit of priority to EP Application Serial No. 23171702.6, filed May 4, 2023 and PCT Application No. PCT/EP2024/062003, filed May 1, 2024, each of which is incorporated herein by reference in their entirety.

### TECHNICAL FIELD

This disclosure relates to a fouling control coating composition, to a substrate or article coated with such a fouling control coating composition, and to a method for controlling aquatic biofouling on man-made objects using such a coating.

### BACKGROUND ART

Fouling of ship hulls and other water-borne objects by aquatic organisms is a continuing problem. Fouling can increase frictional resistance of boats in the water, increasing fuel costs. On static structures, for example on drilling rigs, it can alter the water flow around the supporting legs, risking unpredictable and increased stresses. Fouling can also make inspections more difficult by obscuring defects and cracks. It can further reduce the cross-sectional area of pipework such as cooling water or ballast tank intakes, leading to reduced flow rates.

Coatings can be used to reduce fouling. Such coatings can contain a biocide to control the growth of aquatic organisms on the surface. These fall typically into two broad categories, namely “hard” antifouling coatings, where biocide gradually leaches from the coating over time, and “eroding” antifouling coatings (sometimes called self-polishing coatings), where the coating gradually erodes to release the biocide. However, biocides can carry environmental risks, particularly in areas with heavy shipping activity. They are therefore the subject of increasingly stringent environmental legislation.

Biocide-free coatings are available, which include so-called “fouling release” coatings, which have a low surface energy surface that inhibits adherence of fouling organisms, and also causes them to be more easily washed from the surface. The fouling control effects can be enhanced by including non-biocidal adhesion reducing fluids in the formulation. Biocide-free self-polishing coatings can also be used, so-called surface active self-polishing coatings, where the gradual wear or dissolution continually presents a new, clean surface that is designed to prevent biofouling settlement and growth, and which promotes its release. Examples are described in WO2004/081121 and WO2009/011332.

Some fouling control coatings can comprise rosins or rosin derivatives, as described for example in CN103881576, EP0877061, EP1036786, EP1479737, EP2368949, EP2489710, EP2489711, JP3368618, JP3774310, JP2006077095, KR101115200, KR101137563, KR101970431, US2003/0225184, US2009/0042042, U.S. Pat. Nos. 5,116,407, 5,236,493, 5,298,061, WO91/15546, WO96/04341 and WO2015/150249.

However, there remains a need for further types of fouling control coatings with improved properties.

### SUMMARY

The present disclosure is a fouling control coating composition comprising (i) a siloxane-modified anionic polymer with one or more metallic cations, and (ii) an amine having at least one amine group attached to a saturated carbon atom, a boiling point (at atmospheric pressure) of at least 85° C., and a molecular weight of at least 70.

The present disclosure is also directed to a method for controlling aquatic biofouling on a man-made object, comprising applying the above coating composition onto the surface of a man-made structure. The man-made structure is one that is intended to be permanently or intermittently immersed in water, e.g. sea water, fresh water or brackish water.

The disclosure is further directed to a substrate or article coated with the above-mentioned fouling control coating composition, both before and after drying and/or curing.

The disclosure is additionally directed to the use of such a coating composition for controlling aquatic biofouling of a man-made structure.

### Terminology

In the discussion below, reference to quantities of components in the coating composition as a whole are to the uncured or undried composition, unless otherwise stated. Also, unless otherwise stated, concentrations given are in wt % of the coating composition as a whole. Where a coating composition is provided in separate parts (e.g. a binder-containing part and a curing agent-containing part) the amount of a component in the coating composition as a whole is based on the total amount of components in all the different parts combined.

References to “terminal” groups in a resin, polymer or oligomer are to groups bound to the oligomer/polymer chain or “backbone” at the end (terminal) positions. References to “pendant” groups are to groups attached to the oligomer/polymer chain at positions other than terminal positions.

References to “aliphatic hydrocarbyl” groups or substituents include saturated and unsaturated hydrocarbyl groups (e.g. alkyl or alkenyl groups), which can be cyclic, linear or branched, or comprise a mixture of cyclic and non-cyclic portions. Similarly, references to “alkyl” or “alkenyl” groups or substituents includes cyclic, linear or branched groups, or groups comprising a mixture of cyclic and non-cyclic portions. Unsaturated groups, for example alkenyl groups, have a minimum of two carbon atoms.

References to “aryl” are to aromatic hydrocarbon groups that can comprise one or more aromatic rings. References to “heteroaryl” are to aromatic groups that comprise one or more heteroatoms in the aromatic ring, typically selected from oxygen, nitrogen and sulfur.

The monomer (or monomer unit) content of a polymer or oligomer, expressed in either weight % or molar %, can be calculated from, respectively, the weight fraction or the mole fraction of monomer used to make the polymer or oligomer.

The term “monomer unit” refers to a constituent monomer of a polymer, i.e. to the moiety derived from the monomer after being incorporated into a polymer.

Atmospheric pressure is defined as 1.013 bar-a, where bar-a represents bar-absolute (as opposed to bar-gauge).

The term “saturated carbon atom” refers to a carbon atom that has four single covalent bonds to other atoms, and no double or triple covalent bonds to other atoms.

### DETAILED DESCRIPTION

### [Anionic Polymer]

The coating composition comprises one or more binder resins, at least one of which is a siloxane-modified anionic polymer comprising one or more metallic cations. The anionic polymer can be formed from at least one monomer with an anionic functionality, in which one or more metallic cations are used to balance the negative charge. In embodiments, it is a thermoplastic polymer.

Examples of anionic polymers include those having an anionic moiety selected from phosphonate, sulfonate, carboxylate and carbonate. In embodiments, the anionic moiety, or at least one anionic moiety, is carboxylate.

The amounts of metallic cation-containing siloxane-modified anionic polymer in the coating composition will typically be in the range of from 20 to 80 wt %, for example 20 to 75 wt %, from 25 to 70 wt % or from 25 to 60 wt %.

### [Metallic Cations]

The metallic cations can be selected from divalent or trivalent metal ions. In embodiments, they can be selected from alkaline earth metal ions (e.g. Mg, Ca, Sr), transition metal or “d-block” ions (e.g. first row transition metals such as Ti, Fe, Co, Ni, Cu, Zn), main-group “p-block” metals (e.g. Al, Sn), and lanthanides (e.g. La, Ce, Pr). They can be selected from Mg, Ca, Zn and Cu, and are typically selected from Cu and Zn.

The metallic cations can be provided in the form of a salt of an anionic monomer, e.g. as a metal salt of an acrylate-based monomer as described in more detail below. In other embodiments, it can be provided in the form of a separate salt, e.g. as a carboxylate salt, examples of which are also provided in more detail below.

The metal cation content of metallic cation-containing siloxane-modified anionic polymer is typically in the range of from 1 to 20 wt %, for example from 2 to 15 wt % or from 2 to 10 wt %.

### [Siloxane Moiety]

The anionic polymer comprises a covalently-bound siloxane moiety. The siloxane moiety can be linear, branched or cyclic, or can comprise a mixture of cyclic and non-cyclic portions or regions. In embodiments, the siloxane moiety comprises from 4 to 150 silicon atoms. In embodiments, the siloxane moiety attached to the anionic polymer can be represented by Formula (1):

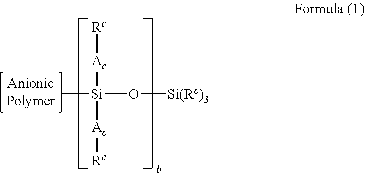

In embodiments the siloxane moiety is bound to the anionic polymer via an oxygen or a carbon atom. Typically, it is bonded to a carbon atom. b is in the range of from 3 to 150, for example in the range of from 3 to 100 or from 8 to 80, and c is in the range of from 0 to 20, for example from 0 to 10, from 0 to 5 or from 0 to 3. In embodiments, c is 0.

Each A is [OSi(R^{c})₂].

Each R^{c} is independently selected from optionally substituted C₁₋₂₀ aliphatic hydrocarbyl groups, optionally substituted C₆₋₁₂ aryl groups, and optionally substituted C₆₋₁₂ aryl groups having one or more C₁₋₆ alkyl groups. Optional substituents are defined further below.

Any alkyl groups can be cyclic or non-cyclic, or can comprise cyclic and non-cyclic portions. Non-cyclic alkyl groups or substituents can be linear or branched.

Each R^{t} is independently selected from H, C₁₋₆ alkyl and C₁₋₆ haloalkyl.

In embodiments, the siloxane moiety can be represented by Formula (2):

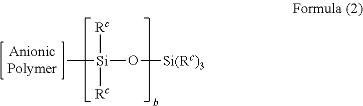

In embodiments, in any of Formulae (1) and (2), there are no halides or halide-containing substituents. In further embodiments of Formulae (1) and (2), there are no optional substituents on any R^{c} group.

In embodiments, the siloxane moiety is a non-functional dimethylpolysiloxane or methylphenylpolysiloxane, where in Formula (2) each R^{c} is unsubstituted methyl or phenyl.

The amount of polysiloxane in the metallic-modified anionic polymer can be in the range of from 20 to 70 wt %, for example in the range of from 30 to 65 wt %.

The molecular weight of the polysiloxane moiety can be in the range of from 800 to 6000, for example from 1000 to 5000, or from 1400 to 3500.

### [Monomer Units of the Anionic Polymer]

The anionic polymer is, in embodiments, an acrylate-based polymer or co-polymer. Such polymers or copolymers are obtainable by polymerisation of a mixture of monomers comprising one or more acrylate-based monomers. An acrylate-based monomer is a monomer having a moiety in which a C═C double bond is directly bonded to a carboxyl, carboxylate or amide group.

In embodiments, the acrylate-based polymer comprises one or more carboxylate-containing acrylate-based monomer units represented by Formula (3):

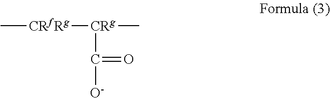

Each R^{f} is selected from H, C₁₋₂₀ aliphatic hydrocarbyl, C₆₋₁₂ aryl, and C₆₋₁₂ aryl with one or more substituents selected from C₁₋₆ alkyl, C(O)O⁻ and C(O)OR^{t}.

Each R^{g} is independently selected from H and C₁₋₂₀ aliphatic hydrocarbyl (e.g. alkyl), C₆₋₁₂ aryl and C₆₋₁₂ aryl substituted with one or more (e.g. 1 to 4) C₁₋₆ aliphatic hydrocarbyl groups. Each aliphatic hydrocarbyl substituent, aliphatic hydrocarbyl group and aryl group in R^{f} and R^{g} can also optionally be substituted as described further below.

In embodiments, the C₁₋₂₀ aliphatic hydrocarbyl can be selected from C₁₋₁₀ or C₁₋₆ aliphatic hydrocarbyl groups, such as C₁₋₁₀ or C₁₋₆ alkyl groups. In embodiments, each R^{g} is selected from hydrogen and methyl.

In embodiments, the R^{g} groups are selected independently from H and unsubstituted C₁₋₆ alkyl, for example H and C₁₋₄ alkyl, such as H and methyl. In embodiments, R^{f} is selected from H, —C(O)O⁻, —C(O)OR^{t}, and C₁₋₆ alkyl optionally substituted with one or more groups selected from —C(O)O⁻ and —C(O)OR^{t}. In embodiments, where R^{f} is an optionally substituted C₁₋₆ alkyl group, there is only one optional —C(O)O⁻ or —C(O)OR^{t} substituent.

In embodiments, the acrylate-based polymer is a co-polymer comprising one or more additional monomer units. In various embodiments, one or more additional monomer units can be selected from those represented by Formula (4):

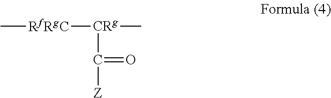

R^{f} and R^{g} are as defined above. Z is selected from —OR^{h} and —N(R^{h})₂.

In embodiments, group Z is selected from OR^{h}, for example OR^{t}.

In embodiments, where Z is N(R^{h})₂, none of R^{f} and R^{g} contain any carbonyl-containing moieties, i.e. —C(O)O⁻, —C(O)OR^{t} or —C(O) NR^{t}₂.

Each R^{h} is independently selected from H and C₁₋₂₀ alkyl, optionally substituted as set out further below. In embodiments, the C₁₋₂₀ alkyl is C₁₋₁₀ or C₁₋₆ alkyl.

In embodiments, the monomer(s) of Formula (3) can be based on acrylate, methacrylate, itaconate, maleate, or crotonate. These also apply for monomer(s) of Formula (4), but they can also include acrylamide and methacrylamide. In embodiments, monomers of Formula (3) are based on acrylate or methacrylate, and those of Formula (4) are based on acrylate, methacrylate, acrylamide or methacrylamide.

In embodiments, there is at least one monomer unit of Formula (4) comprising a siloxane moiety as a substituent on an R^{h} group, e.g. where Z is OR^{h}, and where the siloxane moiety can be:

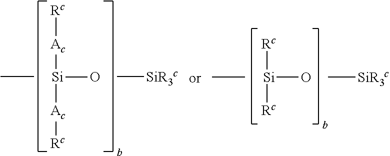

In such embodiments, the R^{h} can be selected from C₁₋₆ alkyl.

Other types of co-monomer (i.e. non acrylate-based monomers) that can form part of the anionic polymer include those having polymerizable unsaturated carbon-carbon bonds, for example those represented by Formula (5):

$${CR}_{2}^{j} = {CR}^{j} {R}^{k} \qquad Formula ( 5 )$$

Each R^{j} is independently selected from H, halide (e.g. selected from F and Cl), and C₁₋₆ alkyl. R^{k} can be selected from Ri, C₂₋₆ alkenyl, C₆₋₁₂ aryl and C₆₋₁₂ aryl substituted with one or more C₁₋₆ aliphatic hydrocarbyl groups. In embodiments, only one of R^{j} and R^{k} can be a halide or comprise a halide-containing substituent. In embodiments R^{k} comprises C₆₋₁₂ aryl. In embodiments, the co-monomer can comprise one or more optional substituents, as set out below for R^{h} and R^{g}.

The average number of monomer units in the acrylate-based anionic polymer can be in the range of from 5 to 500, for example from 10 to 300.

In embodiments, an optionally substituted group can comprise from 1 to 4 substituents, for example 1 or 2 substituents.

In embodiments, the viscosity of the siloxane-modified anionic polymer is in the range of from 3 to 100 Poise, for example from 5 to 50 Poise, when measured at 25° C.

In embodiments, the metallic cation-containing siloxane-modified anionic polymer is made using anionic monomers in their acidic, i.e protonated form, e.g. where the monomer units are of Formula (4) where Z is OH, and subsequently exchanging the H ions with one or more metallic cations.

When making the siloxane-modified anionic polymer, the proportion of the anionic monomers (or protonated forms of the anionic monomers) in the mixture of monomers is typically in the range of from 0.5 to 20 wt %, for example from 1 to 12 wt %, such as from 2 to 10 wt %.

In embodiments, on a molar basis, the anionic monomer is an acrylate-based anionic monomer comprising at least 80% on a molar basis of monomer units according to Formulae (3) and (4). In further embodiments this amount is at least 90% or at least 95% on a molar basis. In still further embodiments, all monomer units are according to Formula (3) and (4).

In embodiments, in the anionic polymer, the amount of metal cations to anionic monomer units in the polymer is at least 80 mol %, for example at least 90 mol % or at least 95 mol %. In this sense, a monomer unit containing acidic groups, e.g. monomer units of Formula (4) where Z is —OH, is considered to be an anionic monomer unit. Otherwise, the anionic polymer can become too soluble, and degrade too quickly when in contact with water.

In embodiments, anionic monomer units that are not charge-balanced by metallic cations can be charge-balanced by other cations, such as protons or amine cations. In embodiments, substantially all anionic monomer units are charge balanced by metallic cations.

### [Optional Substituents]

Optional substituents for R^{c} and R^{h} can be selected from halide, —OR^{t} and —N(R^{t})₂.

Optional substituents for R^{h} and R^{g} can be selected from halide, —OR^{t}, —N(R^{t})₂, siloxane moieties as defined above, —OC(O)R^{t}, —C(O)N(R^{t})₂, and —OC(O)N(R^{t})₂. Additional optional substituents include polyether, polyamine and polyether/amine groups selected from —([CR^{t}₂]ⱼE-)ₚR^{t} and -E-([CR^{t}₂]ⱼE-)ₚR^{t}. Each E is independently selected from O and NR^{t}. j can be from 1 to 6, such as from 2 to 4, and p can be from 1 to 20. For R^{f}, the same optional substituents apply, with further optional substituents being selected from —C(O)O⁻ and —C(O)OR^{t}.

Any halide substituents or any halides in any of the substituents are typically selected from F and Cl.

### [Other Organic Anions]

The coating composition can comprise one or more further organic anions. They can be ionically bound to the polymer, for example as counter ions where the anionic polymer has a divalent or trivalent metal ion.

In embodiments, the further organic anion is selected from carboxylate anions having at least one carboxylate group. The organic anion typically comprises from 2 to 50 carbon atoms in total.

The organic ion can be a C₂₋₅₀ hydrocarbyl group with at least one carboxyl group and optionally one or more further substituents selected from halide (typically selected from F and Cl), OR^{t} and N(R)₂ where R^{t} is as defined above. In embodiments, it is unsubstituted except for having at least one carboxyl group, for example 1 or two carboxyl groups. In embodiments, there is only one carboxyl group.

The hydrocarbyl group can be a C₄ to C₂₀ hydrocarbyl group selected from aliphatic, aromatic, or aliphatic-substituted aromatic groups.

In embodiments the organic ion is selected from carboxyl-containing compounds with an aliphatic group, e.g. a saturated aliphatic group, for example selected from C₄ to C₂₀ alkyl groups or C₆ to C₂₀ alkyl groups, including fatty acids, naphthenic acids and versatic acids.

The organic ion can be part of a carboxyl-containing compound present in a rosin, for example a rosin selected from gum rosin, wood rosin and tall oil rosin. In embodiments the rosin can be a hydrogenated or disproportionated rosin.

### [Amine Compounds]

The coating composition comprises an amine compound that has a boiling point of at least 85° C. (at atmospheric pressure). In embodiments, the boiling point is at least 100° C., for example at least 200° C. or at least 250° C. In addition, the boiling point is typically no more than 800° C., for example no more than 600° C.

The amine compound has a molecular weight of at least 70, for example in the range of from 70 to 10 000. In embodiments, the molecular weight is at least 100, for example at least 200 or at least 250. In embodiments, the molecular weight is no more than 500, for example no more than 350.

In embodiments, the amine compound has at least one primary or secondary amine group, i.e. one which comprises at least one N—H bond. The primary or secondary amine group (or at least one of the primary or secondary amine groups) is attached to a saturated carbon atom, i.e. it is not attached directly to an unsaturated or aromatic carbon atom.

The primary or secondary amine group can be selected from those of formula —NHR^{t}, where R^{t} is as defined above. In embodiments, for secondary amines, R^{t} can be a C₁₋₄ alkyl or C₁₋₂ alkyl.

In embodiments, the amine group is a tertiary amine group of formula —NR^{v}₂, where R^{v} is selected from C₁₋₆ alkyl and C₁₋₆ haloalkyl. In further embodiments one or both R^{v} groups can be selected form C₁₋₄ alkyl and C₁₋₂ alkyl.

In embodiments, the one or more amine groups are bound to an optionally substituted hydrocarbon frame having from 4 to 50 carbon atoms. In embodiments, the hydrocarbon frame can be linear, branched or cyclic, or comprise a mixture of cyclic and non-cyclic portions. The frame can comprise one or more aromatic rings. The one or more optional substituents can be selected from halide, —OR^{t} and —N(R^{t})₂, where R^{t} is as defined above. Halide, where present, can be selected from F and Cl, although in embodiments there are no halide substituents.

In other embodiments, the amine compound can be selected from polyamines and polyalcoholamines, for example of formula R^{t}E-([CR^{t}₂];E-)ₚR^{t}, where R^{t}, E and j and p are as defined above, such that at least one E group is NH, and the molecule overall conforms to the above boiling point and molecular weight requirements. In embodiments, all E are NR^{t}.

Typically, there are no halide or halide-containing substituents. In embodiments, any substituents other than amine substituents are selected from C₁₋₆ alkyl, for example C₁₋₄ alkyl.

In embodiments, the amine compound comprises a single amine group, which can be a primary, secondary or tertiary amine group. This avoids potentially excessive viscosity increase or gelation arising from increased cross-linking.

In embodiments, the amine compound comprises a cycloaliphatic ring, as can be found for example in rosin amines or pyrrolidine.

In embodiments, the source of the one or more amine compounds is a rosin amine. Rosin amines are commercially available. They are typically derived from an acidic rosin, i.e. comprising one or more carboxyl groups, which are then converted into amine by suitable reactions, e.g. via reaction with ammonia or an amine to form a corresponding amide, and subsequent conversion to amine via reduction or Hoffmann rearrangement.

In embodiments the rosin amine compound comprises a diterpenoid “skeleton”, for example comprising three rings. The rings can be saturated, unsaturated or aromatic, or any mixture thereof.

In embodiments, the rosin amine compound can be of Formula (6):

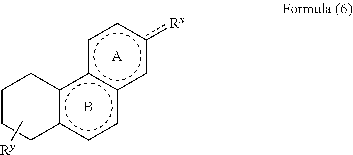

Ring A is an alicyclic C₆ ring or an aromatic C₆ ring. The alicyclic Ce ring comprises zero, one or two C═C double bonds.

Ring B is an alicyclic C₆ ring that has zero or one C═C double bond.

The bond between Ring A and group R^{x} can be a single or double bond.

R^{x} is selected from C₁₋₂₀ aliphatic hydrocarbyl, which can optionally be substituted with one or more substituents selected from halide (typically from F and Cl), —OR^{t} and —N(R^{t})₂. In embodiments, R^{x} is a —C(R^{t})₃ group or a ═C(R^{t})₂ group where each R^{t} is H or an unsubstituted aliphatic hydrocarbyl such as C₁₋₆ alkyl.

R^{y} is —([CR^{t}₂]ⱼNR^{t}—)ₚH, where R^{t} and j and p are as defined above.

Optionally, the rings of Formula (6) can have one or more substituents selected from halide (typically selected from F and Cl), OR^{t}, N(R^{t})₂ and R^{x}. In embodiments, the compound of Formula (6) has no halide or halide-containing substituents. In embodiments, the C₁₋₂₀ aliphatic hydrocarbyl group is an optionally substituted C₁₋₆ alkyl or C₁₋₆ alkenyl group.

In embodiments, the amine compound (or at least one amine compound) is of Formula (7)

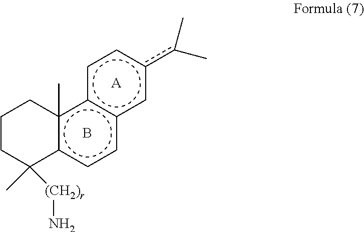

In Formula (7), r can be from 1 to 6, for example from 1 to 2, and in embodiments it is 1.

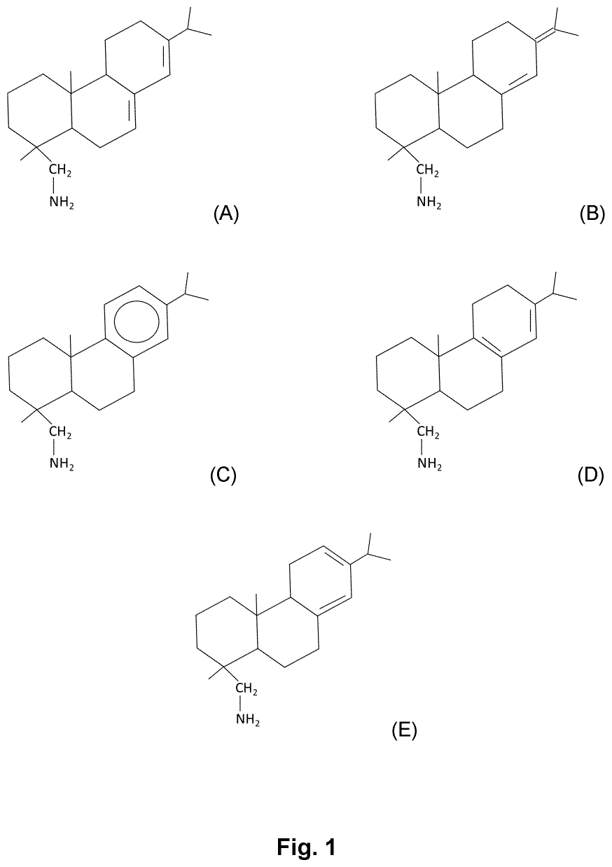

In embodiments, the rosin amine, or at least one of the rosin amines, is selected from those in FIG. 1.

One or more of the amine compounds can be used. For example, when using a rosin amine, commercial sources often comprise more than one type of amine moiety of Formula (6) or (7). In embodiments, the amine or at least one amine is abietylamine or dehydroabietylamine.

The coating composition can comprise in the range of from 0.1 to 30 wt % of the one or more amine compounds, for example 0.5 to 30 wt %, 1 to 30 wt % or 1 to 25 wt %.

Use of amine compounds as described above can help avoid cracking of the coating film (once applied and dried or cured) and improve mechanical integrity, thus reducing or avoiding the need to add plasticizers to the formulation. In embodiments, there is less than 2 wt % plasticizer, for example less than 1 wt % or less than 0.5 wt % plasticizer in the coating composition.

### [Additional Components]

The coating composition may optionally also contain other components, for example one or more substance selected from curable resins, crosslinking agents, reactive diluents, anti-corrosion additives, pigments, gloss additives, waxes, rosins, fillers and extenders, thixotropic agents, plasticizers, inorganic and organic dehydrators (stabilizers), UV stabilizers, defoamers, and any combination thereof. These components are well-known to the skilled person.

The total amount of such further optional components can be in the range of from 0 to 65 wt % based on the total content of the coating composition, typically no more than 50 wt %, for example no more than 35 wt % of the coating composition.

Except for organic solvents, marine biocides, pigments, fillers and extenders, which are discussed further below, the coating composition can comprise less than 5 wt % or less than 3 wt % in total of further optional components.

The coating compositions can have low amounts of non-volatile and non-reactive oligomeric or polymeric fluids (e.g. polysiloxane oils or fluoropolymers such as perfluoropolyethers), or hydrocarbon wax or oil mixtures (e.g petrolatum), or even no such non-volatile and non-reactive fluids. For example, their content can be 5 wt % or less, such as 3 wt % or less, 1 wt % or less or 0.1 wt % or less.

### [Organic Solvents]

The composition can comprise one or more organic solvents. These are typically organic liquids that have a boiling point of 250° C. or lower at atmospheric pressure (i.e. 101.3 kPa or 1.013 bar-a), and evaporate from the coating composition during the drying and curing process.

They can be selected from hydrocarbon compounds and heteroatom-containing organic compounds, where heteroatoms are selected from O, S and N, for example O.

Examples of organic solvents include alkyl aromatic hydrocarbons (such as xylene, toluene and trimethyl benzene), aliphatic hydrocarbons (such as cyclic and acyclic hydrocarbons selected from C₄₋₂₀ alkanes, or mixtures of any two or more thereof), alcohols (such as benzyl alcohol, octyl phenol, resorcinol, n-butanol, isobutanol and isopropanol), ethers (such as methoxypropanol), glycol ethers (e.g. phenyl, benzyl or C₁₋₄ alkyl ethers or diethers of ethylene glycol, diethylene glycol, propylene glycol or dipropylene glycol), ketones (such as methyl ethyl ketone, methyl isobutyl ketone and methyl isopentyl ketone), and esters (such as butyl acetate). In embodiments, the organic solvent comprises from 2 to 20 carbon atoms, for example from 3 to 15 carbon atoms. Mixtures of any two or more organic solvents can be used.

The total amount of organic solvent can constitute up to 80 wt % of the total weight of the coating composition, for example in the range of from 10 to 80 wt %, from 20 to 80 wt % or from 25 to 65 wt %.

The organic solvent content is separate to the water content. The coating composition is typically a non-aqueous composition. Although water can be present, it is typically at a low concentration. If present, it is typically at concentrations of 5 wt % or less, for example 1 wt % or less.

### [Marine Biocides]

The coating composition can, in embodiments, comprise one or more marine biocides. These are chemical substances known to have chemical or biological biocidal activity against marine or freshwater organisms.

Although the coating compositions described herein do not require any additional marine biocides, they can be incorporated if desired. In embodiments, where marine biocide is present, it can be included at concentrations of up to 50 wt %, for example up to 30 wt % or up to 10 wt %. However, in embodiments, there are limited quantities of marine biocide, for example 1 wt % or less, such as 0.5 wt % or less, or 0.1 wt % or less based on the entire coating composition. In embodiments, the coating composition is free of marine biocide.

If used, examples of suitable marine biocides are well-known in the art and include inorganic, organometallic, metal-organic or organic biocides.

Examples of inorganic biocides include copper compounds such as copper oxide, copper thiocyanate, copper bronze, copper carbonate, copper chloride, copper nickel alloys, and silver salts such as silver chloride or nitrate.

Organometallic and metal-organic biocides include zinc pyrithione (the zinc salt of 2-pyridinethiol-1-oxide), copper pyrithione, bis(N-cyclohexyl-diazenium dioxy) copper, zinc ethylene-bis(dithiocarbamate) (i.e. zineb), zinc dimethyl dithiocarbamate (ziram), and manganese ethylene-bis(dithiocarbamate) complexed with zinc salt (i.e. mancozeb).

Organic biocides include formaldehyde, dodecylguanidine monohydrochloride, thiabendazole, medetomidine, N-trihalomethyl thiophthalimides, trihalomethyl thiosulphamides, N-aryl maleimides such as N-(2,4,6-trichlorophenyl) maleimide, 3-(3,4-dichlorophenyl)-1,1-dimethylurea (diuron), 2,3,5,6-tetrachloro-4-(methylsulphonyl)pyridine, 2-methylthio-4-butylamino-6-cyclopopylamino-s-triazine, 3-benzo[b] thien-yl-5,6-dihydro-1,4,2-oxathiazine 4-oxide, 4,5-dichloro-2-(n-octyl)-3 (2H)-isothiazolone, 2,4,5,6-tetrachloroisophthalonitrile, tolylfluanid, dichlofluanid, diiodomethyl-p-tosylsulphone, capsaicin and substituted capsaicins, N-cyclopropyl-N′-(1,1-dimethylethyl)-6-(methylthio)-1,3,5-triazine-2,4-diamine, 3-iodo-2-propynylbutyl carbamate, medetomidine, 1,4-dithiaanthraquinone-2,3-dicarbonitrile (dithianon), boranes such as pyridine triphenylborane, 2-trihalogenomethyl-3-halogeno-4-cyano pyrrole derivatives substituted in position 5 and optionally in position 1, such as 2-(p-chlorophenyl)-3-cyano-4-bromo-5-trifluoromethyl pyrrole (tralopyril), furanones such as 3-butyl-5-(dibromomethylidene)-2 (5H)-furanone, macrocyclic lactones such as avermectins, for example avermectin B1, ivermectin, doramectin, abamectin, amamectin and selamectin, and quaternary ammonium salts such as didecyldimethylammonium chloride and an alkyldimethylbenzylammonium chloride.

The biocide can, in embodiments, be wholly or partially encapsulated, adsorbed, entrapped, supported or bound. Certain biocides are difficult or hazardous to handle and are advantageously used in an encapsulated, entrapped, absorbed, supported, or bound form. Encapsulation, entrapment, absorption, support or binding of the biocide can provide a secondary mechanism for controlling biocide leaching from the coating system in order to achieve an even more gradual release and long-lasting effect. The method of encapsulation, entrapment, adsorption, support or binding of the biocide is not particularly limited. Examples include the use of mono and dual walled amino-formaldehyde or hydrolysed polyvinyl acetate-phenolic resin capsules or microcapsules as described in WO2006/032019. An example of a suitable encapsulated biocide is encapsulated 4,5-dichloro-2-(n-octyl)-3 (2H)-isothiazolone marketed by Dow Microbial Control as Sea-Nine CR2 Marine Antifouling Agent. Examples of ways in which an absorbed or supported or bound biocide may be prepared include the use of host-guest complexes such as clathrates as described in EP0709358, phenolic resins as described in EP0880892, carbon-based adsorbents such as those described in EP1142477, or inorganic microporous carriers such as the amorphous silicas, amorphous aluminas, pseudoboehmites or zeolites described in WO00/11949.

### [Pigments, Fillers and Anticorrosive Agents]

In embodiments, one or more pigments, fillers and anticorrosion agents can be included in the coating composition.

Examples of suitable fillers include zinc oxide, barium sulphate, calcium sulphate, calcium carbonate, silicas or silicates (such as talc, feldspar, and china clay), including pyrogenic silica, bentonite and other clays. Some fillers, such as fumed silica, may have a thixotropic effect on the coating composition.

The proportion of fillers may be in the range of from 0 to 25 wt %, based on the total weight of the coating composition. If clay is present, it is in an amount of up to 1 wt %, for example 0.1 to 1 wt %, based on the coating composition as a whole. If a thixotrope is present, it is in an amount of up to 5 wt %, for example from 0.1 to 5 wt %, based on the total weight of the coating composition.

Examples of pigments include black iron oxide, red iron oxide, yellow iron oxide, titanium dioxide, carbon black, graphite, red molybdate, yellow molybdate, zinc sulfide, antimony oxide, sodium aluminium sulfosilicates, quinacridones, phthalocyanine blue, phthalocyanine green, indanthrone blue, cobalt aluminium oxide, carbazoledioxazine, chromium oxide, isoindoline orange, bis-acetoaceto-tolidiole, benzimidazolone, quinaphthalone yellow, isoindoline yellow, tetrachloroisoindolinone, and quinophthalone yellow, and metallic flake materials such as aluminium flakes.

Examples of anticorrosive agents include zinc dust and zinc alloys, and so-called lubricious pigments such as graphite, molybdenum disulfide, tungsten disulphide and boron nitride. If present, they can be in amounts of up to 25 wt % based the coating composition as a whole, for example in the range of from 0.1 to 25 wt %.

In embodiments, where any pigments, fillers or anticorrosive agents are included, they can constitute in total up to 50 wt % of the coating composition based on the total weight of the coating composition, for example up to 40 wt %. In embodiments, there is at least 0.1 wt % of these components, for example at least 5 wt %, at least 10 wt %, or at least 20 wt %. Example ranges include from 0.1 to 50 wt %, from 0.1 to 40 wt %, from 5 to 50 wt %, from 5 to 40 wt %, from 10 to 50 wt %, from 10 to 40 wt %, from 20 to 50 wt % and from 20 to 40 wt %.

### [Properties of the Coating Composition]

The coating composition in embodiments has a non-volatile content of 35 wt % or more, based on the entire weight of the coating composition. In further embodiments, the non-volatile content is 50 wt % or more, for example 70 wt % or more. In embodiments the non-volatile content is 85 wt % or less. Non-volatile content can be determined according to ASTM D2697, e.g. D2697-03 (2014).

In embodiments, the touch dry time of the coating composition at 23° C. and 50% relative humidity is in the range of from 0.1 to 4 hours, for example in the range of from 0.2 to 3 hours. The touch dry time is the time at which slight pressure with a finger reveals no stickiness and leaves no mark in the coating.

In embodiments, the hard dry time is in the range of from 1 to 30 hours at 23° C. and 50% relative humidity, for example from 2 to 20 hours. The hard dry time is the time at which no film disruption and no marks occur when a thumb is pressed firmly on the surface and twisted through 180°.

### [Preparation of the Coating Composition]

The coating composition may be prepared by mechanical mixing of the components, which can be carried out using conventional means and devices, including agitation mixers such as anchor, paddle, propellor, turbine and helical mixers.

In embodiments, the composition is prepared and provided in the separate parts, such as 2-pack or 2-component (2K) systems. However, typically, the coating composition is a 1-pack (1K) composition, i.e. the formulation is provided in a single pack, such that no mixing of separate curing and binder components is necessary at the point of application.

The coating compositions manage to achieve highly effective fouling control performance, without the need for marine biocide. The combination of the siloxane-modified anionic polymer with the amine compound is also able to contribute surprisingly to lower viscosities, thus reducing the organic solvent demand.

The use of amine compound in combination with siloxane-modified anionic polymer also enables a good combination of flexible yet hard coatings to be achieved. This is an advantage, because often increasing coating flexibility leads to a reduction in coating hardness, and vice versa. The coating also exhibits reduced cracking, without the need for plasticiser to be added to the composition.

In embodiments, the coating is a so-called self-polishing coating, i.e. one that is designed to gradually wear-away or erode with time. Continuous erosion of the surface prevents or at least reduces the duration of attachment of fouling organisms. It has been found that the self-polishing rates of the coating compositions have good long-term consistency of polishing rates, and also have good resistance to cracking.

### [Application of the Coating Composition]

The coating composition can be applied to a substrate by known methods, for example by conventional air-spraying, or by airless- or airmix-spraying equipment. It can alternatively be applied using brush or roller, for example when used as a stripe coat, or for smaller vessels such as yachts. The composition can be applied at ambient conditions without pre-heating the coating composition. In spraying applications, conventional pressures such as 3 to 6 bar-a (bar-absolute) can be used.

The coating is typically applied so that a total dry film thickness of from 100-1000 μm is obtained, such as 100-500 μm or 150-350 μm. The applied film thickness can vary depending on the nature of substrate being coated and the environment to which it will be exposed.

### [Coating Systems]

The coating composition can be used on its own or can be part of a coating system comprising more than one coating composition. It can be applied directly to a substrate surface or to a previously coated surface. For example, it can be applied on top of a primer, or an intermediate coat such as a tie-coat.

A particular benefit of the above-described coating compositions is the ability to combine the desirable attributes of good adhesion to undercoats or tie-coats, while still having highly effective fouling control properties.

In embodiments, the coating composition is applied directly to a primed surface. In further embodiments, the coating composition is applied to a tie-coat layer. The tie-coat can be on top of a primer layer, or directly on the substrate surface.

In embodiments, the coating composition is applied directly to a bare substrate. In other embodiments, the coating composition is applied to a previously coated substrate, such that it comprises one or more pre-existing and pre-cured and/or dried coating layers.

In embodiments, the coating composition is applied to a primer layer on the substrate. The origin of the primer layer is not particularly limited, although in embodiments the primer is an epoxy resin-based primer.

In embodiments, the coating composition is applied to a tie-coat layer on the substrate, in which tie-coat layer is optionally on a primer layer on the substrate.

In embodiments, the coating composition forms part of a multi-coat system that additionally comprises a primer and/or a tie-coat.

In embodiments, a tie-coat layer can be applied on top of the primer layer to assist binding of the coating composition with the primer layer. However, in embodiments, no tie-coat is required.

### [Substrate]

The substrate to which the coating is applied can be one that is intended to be immersed, permanently or intermittently, in water. Substrates include metal, concrete, wood or polymeric surfaces.

Polymeric surfaces include polyvinyl chloride (PVC), or composites of fibre-reinforced resins. They also include flexible polymeric carrier foils, e.g. a PVC carrier foil to which the non-coated side is or can be adhered to a different surface.

In embodiments, the substrate is a submergeable surface of a boat or ship, e.g. selected from one or more of the hull(s) (or at least the draft portion of the hull(s)), the propeller(s), and the rudder(s).

### EXAMPLES

The disclosure will now be described with reference to the following, non-limiting examples.

### [Metallic Cation-Containing Siloxane-Modified Acrylate-Based Polymers]

The amounts of materials (in wt %) used in preparing metallic cation-containing siloxane-modified acrylate-based polymers are listed in Table 1.

Approximately 75% of the total amount of solvents (by weight) were added to a polymerisation reaction vessel and heated to 100° C. The monomers and the “azo” initiators were dissolved in 10% of the solvents, and then added dropwise to the polymerisation vessel under constant stirring over a 5 hour period. Once added, a solution of the peroxide in the remaining 15% of the solvents was then added over a 30 minute period. The reaction was maintained for 90 minutes before being allowed to cool to room temperature.

The resulting resin solution was then mixed with zinc oxide and naphthenic acid and heated under constant stirring at 105° C. for 10 hours, before being allowed to cool to room temperature.

TABLE 1
Reaction Mixtures for Polymer Synthesis (wt %)

| | | | |
|---|---|---|---|
| Ingredient | Anionic Polymer 1 | Anionic Polymer 2 | Anionic Polymer 3 |

Monomers:

| | | | |
|---|---|---|---|
| Acrylic acid | 3.34 | 1.59 | 1.58 |
| Methacrylic acid | 0.00 | 1.82 | 1.81 |
| Methacryl-modified PDMS^{[1]} | 22.25 | 22.74 | 22.58 |
| Methyl methacrylate | 9.79 | 8.19 | 9.94 |
| Ethyl acrylate | 0.00 | 6.82 | 0.00 |
| Butyl acrylate | 4.67 | 0.00 | 4.74 |

Initiators:

| | | | |
|---|---|---|---|
| Azobis(isobutyronitrile) | 0.00 | 1.14 | 0.00 |
| Azobis(methylbutyronitrile) | 1.56 | 0.45 | 1.58 |

Peroxide:

| | | | |
|---|---|---|---|
| t-butyl peroxy-2- | 0.22 | 0.23 | 0.23 |
| ethylhexanoate | | | |

Solvents:

| | | | |
|---|---|---|---|
| Solvent naphtha | 23.88 | 0.00 | 24.23 |
| Xylene | 0.00 | 23.88 | 0.00 |
| 1-methoxypropan-2-ol | 17.51 | 17.51 | 17.77 |

Others:

| | | | |
|---|---|---|---|
| Zinc Oxide | 3.78 | 3.52 | 3.50 |
| Naphthenic acid^{[2]} | 12.99 | 12.11 | 12.04 |

^{[1]}X-22-174BX - a single end methacryl-modified polydimethylsiloxane from ShinEtsu
^{[2]}Napthenic acid from Umicore, with acid value 200 mg KOH/g.

### [Base Compositions]

The resulting polymer solutions were used to prepare amine-free base formulations according to the ingredients listed in Table 2, with quantities based on weight parts.

Coating compositions were then prepared using these base compositions by adding various amine compounds, whose boiling points and molecular masses are listed in Table 3. The amounts of materials used in preparing the coating compositions are listed in Table 4.

TABLE 2
Base compositions for coating compositions (wt %)

| Component | Base Composition 1 | Base Composition 2 | Base Composition 3 |
|---|---|---|---|
| Anionic Polymer 1 | 79.0 | | |
| Anionic Polymer 2 | | 79.0 | |
| Anionic Polymer 3 | | | 79.0 |
| Aerosil ™ R972 ^{[1]} | 2.0 | 2.0 | 2.0 |
| Tioxide ™ TR92 ^{[2]} | 18.7 | 18.7 | 18.7 |
| Xylene | 0.3 | 0.3 | 0.3 |

^{[1]} Dimethyldichlorosilane-treated fumed silica (Evonik)
^{[2]} Titanium dioxide (Huntsman)

TABLE 3
Amine Properties

| Amine Compound | Molecular Mass | Boiling Point (° C.) |
|---|---|---|
| Ammonia | 17 | −33 |
| N,N-Dimethylaniline | 145 | 8 |
| Propylamine | 59 | 49 |
| Pyridine | 79 | 115 |
| Aniline | 93 | 184 |
| Triethylamine | 101 | 89 |
| Diisopropylamine | 101 | 84 |
| Pyrrolidine | 71 | 87 |
| Rosin Amine 90^{[1]} | 285 | 384 |

TABLE 4
Coating Compositions (wt parts)

| | Coating Composition | | | | | | | | | | | |
|---|---|---|---|---|---|---|---|---|---|---|---|---|
| Component | 1 | 2 | 3 | 4 | 5 | 6 | 7 | 8 | 9 | 10 | 11 | 12 |
| Base Comp. 1 | 100 | 100 | 100 | 100 | | | | | | | | |
| Base Comp. 2 | | | | | 100 | 100 | 100 | 100 | | | | |
| Base Comp. 3 | | | | | | | | | 100 | 100 | 100 | 100 |
| Rosin amine^{[1]} | 3.3 | 6.5 | 9.8 | 13.0 | 3.1 | 6.3 | 9.4 | 12.5 | 6.3 | 9.4 | 12.5 | 15.6 |
| | 13* | 14* | 15* | 16* | 17* | 18 | 19* | 20 | 21 | 22 | 23 | 24* |
| Base Comp. 1 | | | | | | | | | | | 100 | |
| Base Comp. 3 | 100 | 100 | 100 | 100 | 100 | 100 | 100 | 100 | | 100 | | |
| Anionic Pol. 3 | | | | | | | | | 100 | | | |
| Silyl-copol. ^{[2]} | | | | | | | | | | | | 100 |
| NH₃ ^{[3]} | 0.7 | | | | | | | | | | | |
| DMA ^{[4]} | | 1.8 | | | | | | | | | | |
| Propyl-amine | | | 2.4 | | | | | | | | | |
| Pyridine | | | | 3.2 | | | | | | | | |
| Aniline | | | | | 3.7 | | | | | | | |
| Triethyl-amine | | | | | | 4.0 | | | | | | |
| Di-iPr-amine^{[5]} | | | | | | | 4.0 | | | | | |
| Pyrrolidine | | | | | | | | 2.8 | | | | |
| Rosin amine^{[1]} | | | | | | | | | 15.8 | 12.7 | 15.8 | 15.8 |

^{[1]}Rosin Amine 90 (min. 90% amine content) from Langley-Smith & Co Ltd, UK; CAS 61790-47-4
^{[2]} Nittest Dolphin ™ (Nitto Kasei) - 50% dispersion of silyl methacrylate-functional methacrylate copolymer in xylene
^{[3]} Provided as 1.9 wt parts of a 35 wt % aqueous solution
^{[4]} N,N-dimethylaniline
^{[5]}Di-isopropylamine
*Comparative Example

### [Antifouling Activity]

Coatings were applied in a 6×6 “latin square” arrangement on plywood test panels. The panels were immersed in sea water in Singapore or the north-east coast of England, and periodically checked for bio-fouling. The extent of observed fouling was assigned on a scale of 1 to 10, where 1 is very low and 10 is very high fouling. Results are given in Tables 5 to 9.

TABLE 5
Fouling Results in Singapore

Weeks

| Material | 19 | 26 | 35 | 45 | 61 |
|---|---|---|---|---|---|
| Coating Composition 11 | 6 | 6 | 8 | 9 | 9 |
| Coating Composition 13* | 7 | 6 | 7 | 7 | 10 |
| Intersleek ™ 1100SR ^{[1]} | 6 | 8 | 9 | 8 | 8 |
| Intergard ™ 263 ^{[2]} | 10 | 10 | 10 | 10 | 10 |

^{[1]} International ™ Paint polysiloxane-based foul release coating
^{[2]} International ™ Paint tie-coat (not a fouling control top-coat product)

TABLE 6
Fouling Results in Singapore

Weeks

| Material | 17 | 24 | 33 | 42 |
|---|---|---|---|---|
| Base Composition 3 | 3 | 3 | 7 | 3 |
| Coating Composition 11 | 2 | 4 | 7 | 3 |
| Coating Composition 13* | 2 | 3 | 5 | 4 |
| Micron ™ 350 ^{[1]} | 2 | 2 | 3 | 3 |
| Intersleek ™ 1100SR | 8 | 6 | 7 | 5 |

^{[1]} International ™ Paint self-polishing coating

TABLE 7
Fouling Results in Singapore

| | Weeks | | |
|---|---|---|---|
| Material | 9 | 19 | 30 |
| Base Composition 2 | 3 | 3 | 4 |
| Coating Composition 5 | 4 | 3 | 3 |
| Coating Composition 6 | 3 | 4 | 5 |
| Coating Composition 7 | 4 | 5 | 5 |
| Coating Composition 8 | 4 | 6 | 6 |
| Micron ™ 350 | 2 | 3 | 3 |

TABLE 8
Fouling Results Singapore

Weeks

| Material | 9 | 19 | 22 | 36 |
|---|---|---|---|---|
| Base Composition 1 | 2 | 2 | 2 | 2 |
| Coating Composition 1 | 2 | 2 | 2 | 2 |
| Coating Composition 2 | 3 | 3 | 3 | 2 |
| Coating Composition 3 | 2 | 3 | 3 | 3 |
| Coating Composition 4 | 2 | 3 | 3 | 3 |
| Micron ™ 350 | 3 | 2 | 3 | 3 |

TABLE 9
Fouling Results in North-East England

Weeks

| Material | 7 | 15 | 36 | 50 |
|---|---|---|---|---|
| Coating Composition 11 | 1 | 1 | 1 | 2 |
| Coating Composition 21 | 1 | 1 | 1 | 2 |
| Intersleek ™ 1100SR | 1 | 2 | 2 | 3 |
| Intergard ™ 263 | 2 | 3 | 5 | 5 |

These results generally show that the coating compositions described herein exhibit fouling control activity that is comparable to that of commercially available fouling control coating compositions.

### [Microhardness, Viscosity and Flexibility]

A Fischer microhardness and sheen cone and plate viscometer was used to collect measurements. The tests were performed on coated glass panels, the coating being applied at a wet film thickness of 200 μm. Viscometer experiments were run for 15 seconds at 25° C. with a rotation rate of 750 rpm.

The panels were left to dry for one week at ambient temperature prior to testing. Results comparing the different anionic polymers and amounts of resin are shown in Table 10. Separately collected results using different amine compounds are shown in Table 11.

TABLE 10
Microhardness and Viscosity (different
anionic polymers and amounts of amine)

| Material | Microhardness (N/mm²) | Viscosity (Poise) |
|---|---|---|
| Rosin amine 90 | — | 54.49 |
| Base Composition 1 | 10.31 | 39.17 |
| Coating Composition 1 | 8.93 | 35.07 |
| Coating Composition 2 | 8.29 | 26.54 |
| Coating Composition 3 | 7.06 | 22.14 |
| Coating Composition 4 | 6.21 | 19.54 |
| Base Composition 2 | 10.15 | 45.07 |
| Coating Composition 5 | 11.01 | 37.30 |
| Coating Composition 6 | 9.08 | 24.55 |
| Coating Composition 7 | 8.05 | 19.40 |
| Coating Composition 8 | 7.62 | 16.40 |
| Base Composition 3 | 10.94 | 28.58 |
| Coating Composition 9 | 8.57 | 14.32 |
| Coating Composition 10 | 8.38 | 13.66 |
| Coating Composition 11 | 6.96 | 11.96 |
| Coating Composition 12 | 6.16 | 13.30 |
| Anionic Polymer 3 | 10.08 | — |
| Coating Composition 21 | 9.44 | — |

TABLE 11
Microhardness and Viscosity (different amines)

| | Microhardness (N/mm²) | Viscosity |
|---|---|---|
| Material | after 8 days | (Poise) |
| Base Composition 3 | 10.86 | 42.24 |
| Coating Composition 13* | 11.95 | 11.95 |
| Coating Composition 14* | 11.06 | 17.52 |
| Coating Composition 15* | 10.27 | 13.63 |
| Coating Composition 16* | 10.84 | 13.88 |
| Coating Composition 17* | 11.06 | 17.52 |
| Coating Composition 18 | 10.30 | 22.39 |
| Coating Composition 19* | 10.52 | 22.03 |
| Coating Composition 20 | 9.18 | 10.96 |
| Coating Composition 22 | 8.30 | 15.49 |

These results demonstrate that the coating compositions are of sufficiently low viscosity that they can be applied using airless spraying techniques. It also shows the benefits of amine compounds in generally achieving lower viscosities in the coating composition. However, the amount added should not be excessive, to avoid viscosity increases where the amines have high inherent viscosity.

### [Flexibility]

Flexibility tests were carried out using a conical mandrel according to ASTM D522. Results are shown in Table 12. High mm values represent poor flexibility, whereas low values represent good flexibility. Samples were tested 1 day and 8 days after the substrate was coated, the samples being held at ambient temperature throughout.

TABLE 12
Flexibility

| | Flexibility after 1 | Flexibility after 8 |
|---|---|---|
| Composition | day (mm) | days (mm) |
| Base Composition 3 | 15 | 10 |
| Coating Composition 13* | 0 | 0 |
| Coating Composition 14* | 15 | 20 |
| Coating Composition 15* | 10 | 5 |
| Coating Composition 16* | 10 | 5 |
| Coating Composition 17* | 10 | 10 |
| Coating Composition 18 | 15 | 15 |
| Coating Composition 19* | 20 | 15 |
| Coating Composition 20 | 5 | 5 |
| Coating Composition 11 | 5 | 5 |
| Base Composition 1 | 25 | — |
| Coating Composition 23 | 5 | — |
| Silyl-copolymer ^{[1]} | 25 | — |
| Coating Composition 24* | 25 | — |

^{[1]} Nittest Dolphin ™ (Nitto Kasei) - see above under Table 4

These results show that the coating compositions with amines falling with the above-described scope (i.e. boiling point of at least 85° C., a molecular weight of at least 70, and having an amine attached to a saturated carbon atom, are more flexible than compositions where the amines have different characteristics. Although ammonia helps to achieve good flexibility, the coatings tend to have poorer long-term mechanical performance (see wet/dry cycling results below). The results also show a flexibility benefit of siloxane groups compared to silyl groups on the anionic polymer.

### [Wet/Dry Cycling]

TABLE 13
Wet/dry cycling results

| | Coating Composition ^{[1]} | | | | | | | | | |
|---|---|---|---|---|---|---|---|---|---|---|
| Cycle | BC1 | 1 | 2 | 3 | 4 | BC2 | 5 | 6 | 7 | 8 |
| 0 | 5/5 | 5/5 | 5/5 | 5/5 | 5/5 | 5/5 | 5/5 | 5/5 | 5/5 | 5/5 |
| 1 | 5/5 | 5/5 | 5/5 | 5/5 | 5/5 | 5/5 | 5/5 | 5/5 | 5/5 | 5/5 |
| 2 | 4/4 | 5/5 | 5/5 | 5/5 | 5/5 | 4/4 | 5/5 | 5/5 | 5/5 | 5/5 |
| 3 | 4/4 | 5/5 | 5/5 | 5/5 | 5/5 | 3/4 | 5/5 | 5/5 | 5/5 | 5/5 |
| 4 | 3/3 | 5/5 | 5/5 | 5/5 | 5/5 | 3/3 | 5/5 | 4/4 | 4/4 | 5/5 |
| 5 | 3/3 | 5/5 | 5/5 | 5/5 | 5/5 | 2/3 | 5/5 | 4/4 | 4/4 | 5/5 |
| 6 | 2/2 | 5/5 | 5/5 | 5/5 | 5/5 | 2/1 | 4/4 | 4/4 | 4/4 | 4/4 |
| 7 | 2/2 | 5/5 | 5/5 | 5/5 | 5/5 | 2/1 | 4/4 | 4/4 | 4/4 | 4/4 |
| 8 | 2/2 | 5/5 | 5/5 | 5/5 | 5/5 | 1/1 | 4/4 | 3/3 | 3/3 | 4/4 |
| 9 | 1/1 | 4/4 | 4/4 | 4/4 | 5/5 | 1/1 | 3/3 | 3/3 | 3/3 | 4/3 |
| 10 | 1/1 | 4/4 | 4/4 | 4/4 | 5/5 | 1/1 | 3/3 | 3/3 | 3/3 | 4/3 |
| 11 | 1/1 | 4/4 | 4/4 | 4/4 | 5/5 | 1/1 | 3/2 | 3/3 | 3/3 | 4/3 |
| 12 | 1/1 | 4/4 | 4/4 | 4/4 | 5/5 | 1/1 | 2/2 | 3/3 | 3/3 | 3/3 |

| | BC3 | 9 | 10 | 11 | 12 | 13* |
|---|---|---|---|---|---|---|
| 0 | 5/5 | 5/5 | 5/5 | 5/5 | 5/5 | 5/5 |
| 1 | 5/5 | 5/5 | 5/5 | 5/5 | 5/5 | 5/5 |
| 2 | 2/2 | 5/5 | 5/5 | 5/5 | 5/5 | 5/5 |
| 3 | 1/1 | 5/5 | 5/5 | 5/5 | 5/5 | 5/5 |
| 4 | 1/1 | 5/5 | 5/5 | 5/5 | 5/5 | 5/5 |
| 5 | 1/1 | 5/5 | 5/5 | 5/5 | 5/5 | 4/4 |
| 6 | 1/1 | 5/5 | 5/5 | 5/5 | 5/5 | 3/3 |
| 7 | 1/1 | 4/4 | 4/4 | 5/5 | 5/5 | 1/1 |
| 8 | 1/1 | 4/4 | 4/4 | 5/5 | 5/5 | 1/1 |
| 9 | 1/1 | 4/4 | 4/4 | 5/5 | 5/5 | 1/1 |
| 10 | 1/1 | 4/4 | 4/4 | 4/4 | 5/5 | 1/1 |
| 11 | 1/1 | 4/4 | 4/4 | 4/4 | 5/4 | 1/1 |
| 12 | 1/1 | 3/3 | 4/3 | 4/4 | 4/4 | 1/1 |

^{[1]} BC [number] refers to Base Composition [number]

The experiments were conducted by drawing down the test coatings onto primed steel panels and being left to dry. They were then cycled between a warm seawater environment and a cold dry environment, each immersion lasting 24 hours. The extent of cracking between cycles was assessed on a 1-5 scale, where 5=no cracking and 1=severe cracking. Results are shown in Table 13.

The effects show the improved resistance to cracking when the composition included an amine compound with an anionic siloxane-modified polymer, even in the absence of a plasticizer. However, with low boiling point materials, e.g. ammonia, any benefit is very short lived.

### [Polishing Rate]

Substrates used in these experiments were 23 cm diameter Perspex discs which had been pre-coated with a layer of Intergard™ 263 epoxy tie-coat. The test coats were applied via a 600 μm drawdown cube, and left to dry under ambient conditions for 2 weeks, 5 replica experiments were carried out for each test coating.

TABLE 14
Film loss results (μm)

| | Time (Days) | | | | |
|---|---|---|---|---|---|
| Composition | 0 | 10 | 31 | 104 | 182 |
| Base Composition 1 | 0 | 9.98 | 14.12 | 48.49 | 95.35 |
| Coating Composition 1 | 0 | 13.35 | 17.35 | 35.44 | 51.03 |
| Coating Composition 2 | 0 | 17.22 | 25.01 | 37.79 | 50.04 |
| Coating Composition 3 | 0 | 15.48 | 22.88 | 40.53 | 49.71 |
| Coating Composition 4 | 0 | 16.46 | 28.24 | 46.43 | 60.88 |
| Base Composition 2 | 0 | 8.36 | 14.82 | 32.78 | 133.90 |
| Coating Composition 5 | 0 | 11.17 | 19.32 | 29.78 | 45.44 |
| Coating Composition 6 | 0 | 13.76 | 21.80 | 31.17 | 40.90 |
| Coating Composition 7 | 0 | 15.68 | 23.51 | 38.14 | 41.64 |
| Coating Composition 8 | 0 | 18.23 | 30.04 | 45.71 | 52.41 |

The substrates were immersed in sea-water and rotated at 700 rpm. The film thickness was 5 measured at periodic intervals using a laser profilometer, and the film loss calculated. Results are shown in Table 14.

These results indicate that the self-polishing performance of the amine-containing coatings is more stable over the longer term compared to the amine-free compositions, (base compositions), which tend to deteriorate more rapidly after about 100 days due to mechanical break-down and cracking.

1. A fouling control coating composition comprising (i) a siloxane-modified anionic polymer with one or more metallic cations, and (ii) an amine compound having at least one amine group attached to a saturated carbon atom, a boiling point of at least 85° C., and a molecular weight of at least 70.

2. The fouling control coating composition as claimed in claim 1, which is a self-polishing fouling control coating composition.

3. The fouling control coating composition as claimed in claim 1, in which the siloxane-modified anionic polymer is a polymer made from one or more acrylate-based monomers.

4. The fouling control coating composition as claimed in claim 3, in which there is one or more anionic acrylate-based monomer.

5. The fouling control composition as claimed in claim 3, in which there is one or more acrylate-based monomer comprising a polysiloxane substituent.

6. The fouling control composition as claimed in claim 5, in which the polysiloxane substituent is a polydimethylsiloxane substituent.

7. The fouling control composition as claimed in claim 1, in which the siloxane-modified anionic polymer is a thermoplastic polymer.

8. The fouling control composition as claimed in claim 1, in which one or more of the following apply:
(i) the amine compound comprises only one amine group;
(ii) the amine compound comprises at least one primary or secondary amine group;
(iii) the amine compound comprises a diterpenoid skeleton substituted with one or more amine substituents
(iv) the amine compound has a molecular weight of no more than 500 or no more than 350.

9. The fouling control composition as claimed in claim 1, in which one or more of the following apply:
(i) the amine compound comprises at least one primary or secondary amine group of formula —NHR^{t}, where R^{t} is selected from H, C₁₋₆ alkyl and C₁₋₆ haloalkyl;
(ii) the amine compound comprises a tertiary amine group of formula —NR^{v}₂, where R^{v} is selected from C₁₋₆ alkyl and C₁₋₆ haloalkyl.

10. The fouling control composition as claimed in claim 1, in which the amine compound, or at least one amine compound, is selected from the following:

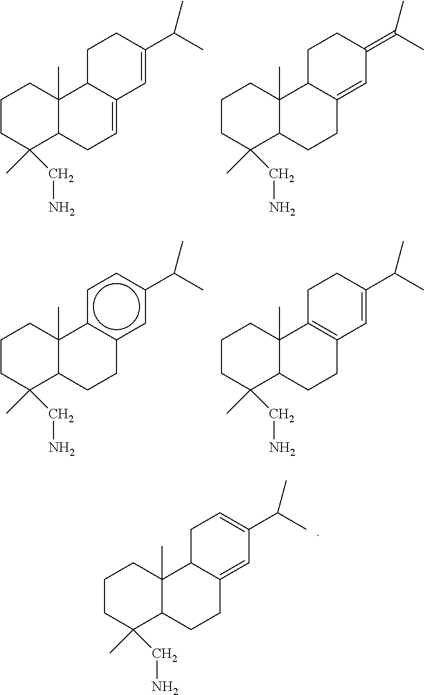

11. The fouling control composition as claimed in claim 10, in which the source of the amine compound(s) is a rosin amine.

12. The fouling control coating composition as claimed in claim 1, in which the metal cations are selected from Mg, Ca, Zn and Cu.

13. A method for controlling aquatic biofouling on a man-made object, comprising applying the fouling control coating composition as claimed in claim 1 onto the surface of the man-made structure, the man-made structure being a structure that is intended to be for permanent or intermittent immersion in water.

14. A substrate or article coated with the fouling control coating composition as claimed in claim 1, before or after being cured.

15. Use of the coating composition as claimed in claim 1 for controlling aquatic biofouling on a man-made structure.

16. Use of an amine compound having at least one amine group attached to a saturated carbon atom, a boiling point of at least 85° C., and a molecular weight of at least 70 in a fouling control coating composition as defined in claim 1, wherein the amine compound is used for one or more of the following:
(i) reducing viscosity of the fouling control composition;
(ii) increasing flexibility of the fouling control composition;
(iii) improving cracking resistance of the fouling control composition;
(iv) improving the long-term stability of the self-polishing rate of the fouling control composition.
